(19) United States
(12) Patent Application Publication
(10) Pub. No.: US 2014/0307221 A1
(43) Pub. Date: Oct. 16, 2014

(54) LENS DEVICE, FRAME, TEMPLE AND MANUFACTURING METHOD THEREOF

(71) Applicant: HWA MEEI OPTICAL CO., LTD., Tainan City (TW)

(72) Inventor: CHIH MING CHEN, TAINAN CITY (TW)

(21) Appl. No.: 13/921,348

(22) Filed: Jun. 19, 2013

(30) Foreign Application Priority Data
Apr. 10, 2013 (TW) 102112697

(51) Int. Cl. G02C 5/00

(52) U.S. Cl. CPC G02C 5/008
USPC 351/83; 351/111; 264/41

(57) ABSTRACT

A frame of a lens device includes a frame portion and a plurality of bubble portions which are disposed in the frame portion. A temple of a lens device is also disclosed, including a temple portion and a plurality of bubble portions which are disposed in the temple portion. A lens device is also disclosed, including the said frame or temple. The manufacturing methods of the said frame and temple are also disclosed.

### BACKGROUND OF THE INVENTION

1. Field of the Invention

The invention relates to a lens device and, in particular, to a lens device, frame, temple, and the manufacturing methods thereof.

2. Description of the Prior Art

The lens device, such as sunglasses, working goggles, nearsighted eyeglasses, farsighted spectacles, presbyopia eyeglasses or the like, have become an indispensable appliance, helping people's living a lot. However, there are still some inconveniences in usage although the eyeglasses industry has been developed to this day. For example, the eyeglasses are too heavy, so that the user getting used to wear eyeglasses is made sunken wings of the nose, which also affects the user's appearance.

Therefore, it is an important subject to provide a lens device that can be decreased in weight for enhancing the using efficiency and product competitiveness.

### SUMMARY OF THE INVENTION

In view of the foregoing subject, an objective of this invention is to provide a lens device, a frame, a temple and manufacturing methods thereof, wherein the weights thereof are decreased so that the using efficiency and product competitiveness can be enhanced a lot.

To achieve the above objective, a frame of a lens device according to the invention comprises a frame portion and a plurality of bubble portions which are disposed in the frame portion.

In one embodiment, the volume of the bubble portions is between 10% and 35% of that of the frame portion.

To achieve the above objective, a temple of a lens device according to the invention comprises a temple portion and a plurality of bubble portions which are disposed in the temple portion.

In one embodiment, the volume of the bubble portions is between 10% and 35% of that of the temple portion.

To achieve the above objective, a lens device according to the invention comprises any one of the above-mentioned frame and at least one lens which is fixed to the frame.

To achieve the above objective, a lens device according to the invention comprises a frame, two above-mentioned temples, and at least one lens. The temples are respectively disposed to the opposite sides of the frame. The lens is fixed to the frame.

To achieve the above objective, a manufacturing method of a frame of a lens device according to the invention comprises steps of: incorporating a gas in a melted plastic material; during the formation of the frame the plastic material with the incorporated gas foams to generate a plurality of bubble portions in the frame.

In one embodiment, the step of forming a frame includes providing a plastic material, and the gas is incorporated in the plastic material so that the plastic material foams in a mold to become the frame.

To achieve the above objective, a manufacturing method of a temple of a lens device according to the invention comprises steps of: forming a temple; incorporating the gas in the melted plastic material; during the formation of the temple the plastic material with the incorporated gas foams to generate a plurality of bubble portions in the temple.

In one embodiment, the step of forming a temple includes providing a plastic material, and the gas is incorporated in the plastic material so that the plastic material foams in a mold to become the temple.

As mentioned above, a plurality of bubble portions are formed in the frame and/or temple of the lens device of the invention by several methods, so the frame and temple can be decreased in weight while maintaining sufficient structural strength. Therefore, the user getting used to wear eyeglasses can take less pressure at the wings of the nose, and thereby the using efficiency and product competitiveness can be enhanced a lot. Besides, since the lens device, frame and temple of the invention is lighter, their densities can be controlled as less than 1, i.e. the density of water. Therefore, when the user doing aquatic sports loses the eyeglasses, the user can easily find them. Furthermore, since the lens device, frame and temple of the invention only consume less material, the environmental protection can be effectively achieved. To be noted, the method of forming the bubble portions in the frame or temple of the invention includes a step of driving a gas into the frame or temple. This method is creative and not complicated, facilitating mass production.

### BRIEF DESCRIPTION OF THE DRAWINGS

FIG. 1 is a schematic diagram of a frame of a lens device according to a preferred embodiment of the invention;

FIG. 1a is a schematic diagram showing an enlarged portion of the frame in FIG. 1;

FIG. 2 is a flow chart of a manufacturing method of a frame of a lens device according to a preferred embodiment of the invention;

FIG. 3 is a flow chart of a practical application of the manufacturing method in FIG. 2;

FIG. 4 is a schematic diagram of a temple of a lens device according to a preferred embodiment of the invention;

FIG. 4a is a schematic diagram showing an enlarged portion of the temple in FIG. 4; and

FIG. 5 is a flow chart of a manufacturing method of a temple of a lens device according to a preferred embodiment of the invention; and

FIG. 6 is a flow chart of a practical application of the manufacturing method in FIG. 5.

### DETAILED DESCRIPTION OF THE INVENTION

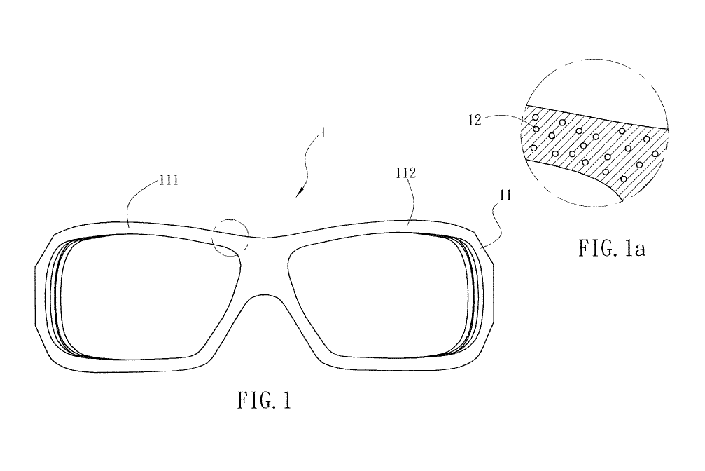

FIG. 1 is a schematic diagram of a frame 1 of a lens device according to a preferred embodiment of the invention, and FIG. 1a is a schematic diagram showing an enlarged portion of the frame 1 in FIG. 1. In the invention, the frame 1 is not limited in type, which can be a frame of sunglasses, working goggles, nearsighted eyeglasses, farsighted spectacles, presbyopia eyeglasses, snow goggles, or the like.

As shown in FIGS. 1 and 1a, the frame 1 includes a frame portion 11 and a plurality of bubble portions 12. The frame portion 11 is used to fix the lens, and therefore it is usually configured with some structure, such as a slot, locking portion or embedding portion. Besides, the shape of the frame portion 11 is often designed according to the number of the lens. For example, if there is only one lens for a lens device covering the range of the two eyes of the user, the slot of the frame portion 11 can be formed from one side of the frame portion 11 to the other side. If there are two lenses for a lens device, the frame portion 11 can have two slots which are respectively corresponding to the two lenses and disposed symmetrically. However, this invention is not limited thereto. In this embodiment, the frame portion 11 has two lens-holding portions 111 and 112 for holding the lenses. The lens-holding portions 111 and 112 each have a closed form. In other embodiments, the lens-holding portions 111 and 112 can have unclosed forms, according to the actual requirements.

Furthermore, as an embodiment, the volume of the bubble portions 12 is between 10% and 35% of that of the frame portion 11, so the frame 1 can maintain sufficient structural strength while decreased in weight. However, the invention is not limited thereto.

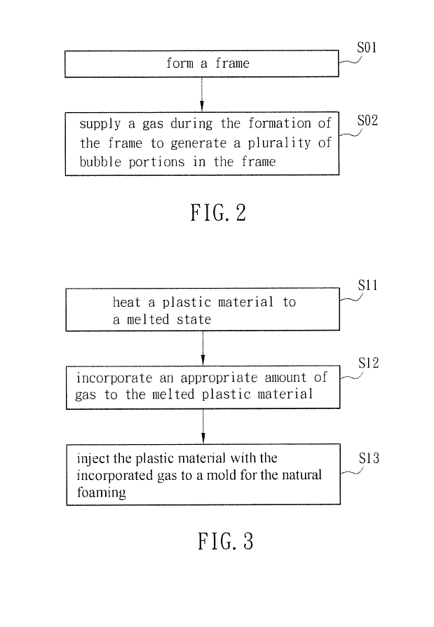

FIG. 2 is a flow chart of a manufacturing method of a frame of a lens device according to a preferred embodiment of the invention, including the steps S01 and S02 As shown in FIGS. 1, 1a and 2, the step S01 is to form a frame 1. This step can be implemented by injection molding, but however, the option of the manufacturing method for the frame 1 can be changed in accordance with the material of the frame 1. The step S02 is to supply a gas during the formation of the frame 1 to generate a plurality of bubble portions 12 in the frame 1. FIG. 3 shows a practical application of the manufacturing method in FIG. 2. As to the injection molding, the step S11 is to heat a plastic material to a melted state, then the step S12 is to incorporate an appropriate amount of gas to the melted plastic material, and then the step S13 is to inject the plastic material with the incorporated gas to a mold for the natural foaming. Thereby, the frame 1 is formed to have bubble portions 12 therein. To be noted, when the melted plastic material with the gas is injected into a low-pressure mold, it will foam more effectively for generating the bubble portions 12. To be noted, in this embodiment, the amount and injection position of the gas can be determined according to the position and size of the bubble portions. In this embodiment, the gas is, for example, carbon dioxide or nitrogen, but this invention is not limited thereto. As an embodiment, the gas amount incorporated in the plastic material is controlled to determine the proportion of the bubble portions.

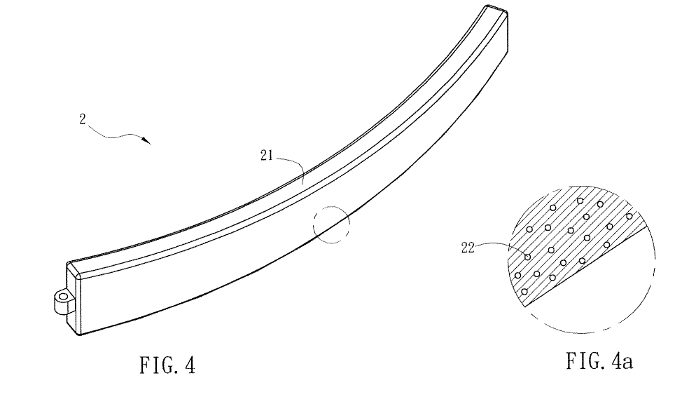

FIG. 4 is a schematic diagram of a temple 2 of a lens device according to a preferred embodiment of the invention, and FIG. 4a is a schematic diagram showing an enlarged portion of the temple 2 in FIG. 3. In the invention, the temple 2 is not limited in type, which can be a temple of sunglasses, working goggles, nearsighted eyeglasses, farsighted spectacles, presbyopia eyeglasses snow goggles, or the like.

As shown in FIGS. 4 and 4a, the temple 2 includes a temple portion 21 and a plurality of bubble portions 22. The temple portion 21 is usually put on the user's ears. For stabilizing the lens device, it usually has some structure, such as a hook or a band-fastening portion for fastening a band of the lens device. However, the invention is not limited thereto. Besides, there are often two temples for a general pair of eyeglasses, and the temples are disposed to the opposite sides of the frame respectively and symmetrically, but this invention is not limited hereto however.

Furthermore, as an embodiment, the volume of the bubble portions 22 is between 10% and 35% of that of the temple portion 21 so that the temple 2 can maintain sufficient structural strength while decreased in weight. However, the invention is not limited thereto.

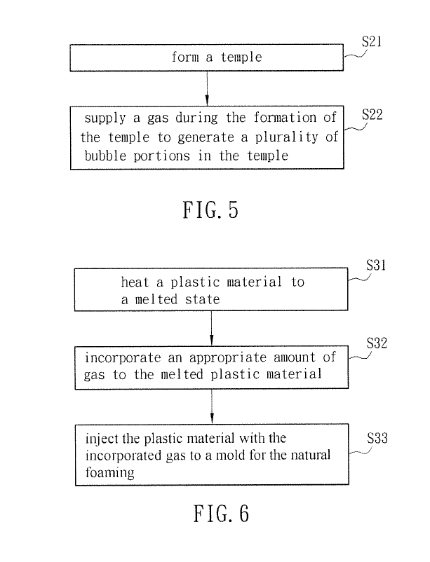

FIG. 5 is a flow chart of a manufacturing method of a temple of a lens device according to a preferred embodiment of the invention, including the steps S21 and S22 As shown in FIGS. 4, 4a and 5, the step S21 is to form a temple 2. This step can be implemented by injection molding, but however, the option of the manufacturing method for the temple 2 can be changed in accordance with the material of the temple 2. The step S22 is to supply a gas during the formation of the temple 2 to generate a plurality of bubble portions 22 in the temple 2. FIG. 6 shows a practical application of the manufacturing method in FIG. 5. As to the injection molding, the step S31 is to heat a plastic material to a melted state, then the step S32 is to incorporate an appropriate amount of gas to the melted plastic material, and then the step S33 is to inject the plastic material with the incorporated gas to a mold for the natural foaming. Thereby, the temple 2 is formed to have bubble portions 22 therein. To be noted, when the melted plastic material with the gas is injected into a low-pressure mold, it will foam more effectively for generating the bubble portions 22. To be noted, in this embodiment, the amount and injection position of the gas can be determined according to the position and size of the bubble portions. In this embodiment, the gas is, for example, carbon dioxide or nitrogen, but this invention is not limited thereto. As an embodiment, the gas amount incorporated in the plastic material is controlled to determine the proportion of the bubble portions.

A lens device according to a preferred embodiment of the invention can include any of the frames as mentioned above and at least one lens. The frame has a plurality of bubble portions, and the lens is fixed to the frame. The lens device of this embodiment is, for example, sunglasses, working goggles, nearsighted eyeglasses, farsighted spectacles, presbyopia eyeglasses, snow goggles, or the like. Besides, another lens device according to a preferred embodiment of the invention can include a frame, two temples as mentioned above, and at least one lens. The temples each have a plurality of bubble portions. The frame can have bubble portions or not. The temples are disposed to the opposite sides of the frame respectively. The lens is fixed to the frame.

In summary, a plurality of bubble portions are formed in the frame and/or temple of the lens device of the invention by several methods, so the frame and temple can be decreased in weight while maintaining sufficient structural strength. Therefore, the user getting used to wear eyeglasses can take less pressure at the wings of the nose, and thereby the using efficiency and product competitiveness can be enhanced a lot. Besides, since the lens device, frame and temple of the invention is lighter, their densities can be controlled as less than 1, i.e. the density of water. Therefore, when the user doing aquatic sports loses the eyeglasses, the user can easily find them. Furthermore, since the lens device, frame and temple of the invention only consume less material, the environmental protection can be effectively achieved. To be noted, the method of forming the bubble portions in the frame or temple of the invention includes a step of driving a gas into the frame or temple. This method is creative and not complicated, facilitating mass production.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A frame of a lens device, comprising:
a frame portion; and
a plurality of bubble portions disposed in the frame portion.

2. The frame as recited in claim 1, wherein the volume of the bubble portions is between 10% and 35% of that of the frame portion.

3. A temple of a lens device, comprising:
a temple portion; and
a plurality of bubble portions disposed in the temple portion.

4. The temple as recited in claim 3, wherein the volume of the bubble portions is between 10% and 35% of that of the temple portion.

5. A lens device, comprising:
a frame as recited in claim 1; and
at least one lens fixed to the frame.

6. A lens device, comprising:
a frame;
two temples as recited in claim 3 respectively disposed to the opposite sides of the frame; and
at least one lens fixed to the frame.

7. A manufacturing method of a frame of a lens device, comprising steps of:
forming a frame; and
supplying a gas during the formation of the frame to generate a plurality of bubble portions in the frame.

8. The manufacturing method as recited in claim 7, wherein the step of forming a frame includes providing a plastic material, and the gas is incorporated in the plastic material so that the plastic material foams in a mold to become the frame.

9. A manufacturing method of a temple of a lens device, comprising steps of:
forming a temple; and
supplying a gas during the formation of the temple to generate a plurality of bubble portions in the temple.

10. The manufacturing method as recited in claim 9, wherein the step of forming a temple includes providing a plastic material, and the gas is incorporated in the plastic material so that the plastic material foams in a mold to become the temple.
